(19) United States
(12) Patent Application Publication
(10) Pub. No.: US 2021/0028508 A1
(43) Pub. Date: Jan. 28, 2021

(54) METHOD FOR DISCHARGING ELECTRICAL STORAGE DEVICES

(71) Applicant: Roland Craig Bruyns, Madison, AL (US)

(72) Inventor: Roland Craig Bruyns, Madison, AL (US)

(21) Appl. No.: 16/940,307

(22) Filed: Jul. 27, 2020

Related U.S. Application Data
(60) Provisional application No. 62/986,001, filed on Mar. 6, 2020.
(60) Provisional application No. 62/879,508, filed on Jul. 28, 2019.

(51) Int. Cl. H01M 10/44; H01M 10/0525

(52) U.S. Cl. CPC H01M 10/44; H01M 10/0525

(57) ABSTRACT

An improved method for discharging electrical storage devices such as batteries and capacitors wherein the electrical storage device comprises a positive terminal and a negative terminal. To discharge the device a plurality of electrically conductive beads are utilized to create a contiguous electrical connection between the positive and negative terminals of the electrical storage device. The contiguous electrical connection allows the electrical storage device to discharge.

### CROSS-REFERENCE TO RELATED APPLICATIONS

This application claims the benefit of provisional patent application Ser. No. 62/986,001 filed Mar. 6, 2020 and provisional patent application Ser. No. 62/879,508 filed Jul. 28, 2019 by the present inventor, which are incorporated by reference.

### BACKGROUND OF THE INVENTION

### 1. Field of the Invention

The present invention is in the field of Lithium Ion battery discharging and recycling.

### 2. Descriptions of Related Art

There is a growing demand for electrical storage devices such as lithium-ion batteries (LIBs)in a variety of applications, including consumer electronics, stationary storage, large industrial applications, and electric vehicles(EVs). Current LIB cathodes contain a substantial amount of cobalt, a critical material that is both expensive and dependent on foreign sources for production. Other valuable materials include components of the cathode (lithium, nickel, and manganese), anode (graphite), and electrolyte. One of the challenges associated with recycling LIB's is the lack of a cost-effective method or technology that will render lithium-based batteries safe or inert allowing safe storage and transport to recyclers.

Several methods are available for rendering LIBs inert or discharging them. One such method that is used for achieving a zero state charge on bulk quantities of Li-ion batteries is a brine solution soak. While this is capable of handling batteries of varying size, construction, capacity and voltage, it may produce explosive Hydrogen gas if the voltages used exceed the electrolysis voltage of water (1.23V). Additionally, analysis of the brine solution after the treatment of Li-ion batteries has shown residual metal content that would necessitate treating the solution as a hazardous waste.

Another method for rendering LIBs safe is the use of resistors or dischargers to short the cells and slowly discharge them. This avoids many of the issues associated with hazardous waste generation and Hydrogen gas generation when using a brine solution, but the use of dischargers requires fixturing and precise mounting of the batteries to ensure they make adequate electrical contact and each battery needs to be individually discharged.

Another technique for stabilizing LIB's is the use of cryogenic freezing. This technique exposes the batteries to cryogenic temperatures and maintains the batteries at depressed temperatures to keep the reactive compounds inside the batteries stable. This technique is expensive, requires proper insulation and packaging if the batteries are to be stored for extended periods or shipped and introduces the risk of the batteries becoming hazardous if they rise back to room temperature.

What is needed is a solution to fundamentally change the way LIB's are made inert. Such a solution would make the batteries inert and safe for storage or transportation without the complexity of discharging them individually, hazardous waste issues or requiring expensive cryogenic treatment.

### BRIEF SUMMARY OF THE INVENTION

The inventive disclosures described herein pertain to an improved method, material and system for safely discharging LIBs to make them inert. In one embodiment the material used for discharging lithium ion batteries are multiple conductive beads. To discharge a battery, the battery is placed in a bed of said beads. Since the beads contact both the positive and negative terminals of the battery they provide a continuous electrical network to discharge the battery.

### BRIEF DESCRIPTION OF THE SEVERAL VIEWS OF THE DRAWINGS

FIG. 1 is a cross sectional view of a battery in a container of conductive beads. The beads form a contiguous network between the positive and negative terminals of the battery providing an electrical connection between the positive and negative terminal of the battery.

FIG. 2 is a graph of the current flow passing through conductive beads contacting the positive and negative terminals of a battery simulator.

### DETAILED DESCRIPTION OF THE INVENTION

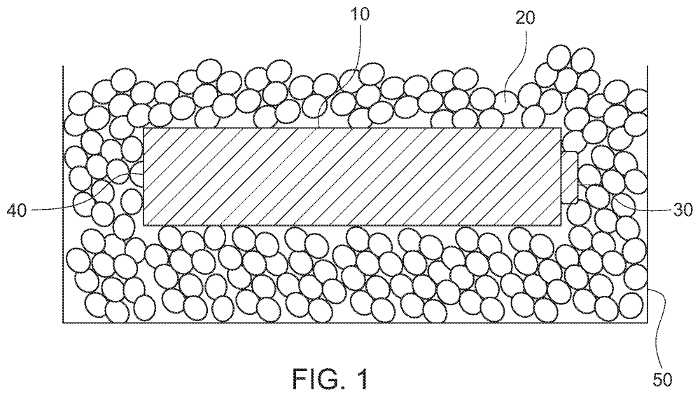

The inventive disclosures described herein pertain to an improved material, method and system for discharging batteries. The term battery may apply to an individual cell, multiple connected cells, modules or battery packs. In one embodiment the system uses electrically conductive beads. When a battery is covered with said beads such that the beads provide a contiguous electrical connection between a positive and negative terminal of the battery then current will flow between the terminals to discharge the battery. As shown in FIG. 1 a battery 10 is placed in a bed of conductive beads 20 held in a container 50. The space between the beads is filled with air. The conductive beads provide a contiguous electrically conductive network between the positive and negative terminals of the battery 30 and 40. The beads provide a safe discharge of the battery without overheating the battery. The plurality of electrically conductive beads 20 may be formed of any suitable electrically conductive material.

In one embodiment the conductive beads are of uniform composition of a material having a conductivity that allows a safe discharge of Lithium Ion Batteries.

In still another embodiment the composition of the conductive beads is a mixture of at least two materials that are evenly dispersed or blended within each other and that have different electrical conductivities resulting in a composite bead that can have tailored electrical properties depending on the relative ratios of the materials used to produce the bead.

In still another embodiment the beads are comprised of metal foil that has been randomly compressed to form a spherical shape.

In still another embodiment the shape of the beads used for discharging LIB's is chosen to be one of several possible shapes including spherical, cylindrical and faceted.

In one embodiment the beads comprise an electrically insulating core with an electrically conductive metal coating on the outside of the beads.

In one embodiment the coating on the outside of the beads is a metal deposited by a spray or tumble coating applied as a paint.

In still another embodiment the metal coating is multilayered and is applied by a combination of electroless or electrolytic deposition.

In another embodiment the metal coating is deposited by a vacuum deposition technique.

In still another embodiment the conductive coating is one of several non-metallic materials, for example polyethylene oxide or polythiophene.

In still another embodiment the conductive coating is a carbon based materials such as graphite, pyrolytic graphite, graphene or carbon black.

In still another embodiment the beads are a carbon based materials such as graphite, pyrolytic graphite, graphene or carbon black.

In still another embodiment the beads are graphite that has been heat treated to increase electrical conductivity.

In still another embodiment the conductive beads are a carbon felt material.

In still another embodiment the conductive beads are a carbon felt material that has been heat treated to increase electrical conductivity.

In still another embodiment beads are a carbon felt material that has been coated with a polymer material to minimize shedding of fiber and dust from the carbon felt.

In still another embodiment the carbon felt material is coated with a polymer material that has a conductive filler.

In still another embodiment the conductive particles are hollow metal cylinders or tube sections.

In still another embodiment the bead is a composite material comprising interconnected phases of a high conductivity and low conductivity material.

In still another embodiment the composite interconnected phases of the bead consist of carbon black as the high conductivity phase and a polymer as the low conductivity phase. Beads such as these can be produced by standard polymer compounding processes.

In still another embodiment the polymer core of the bead contains a phase change material encapsulated in a shell to increase the heat absorption capacity of the beads.

In still another embodiment the bed of media has a flow of air passing through the bed of beads. The air flow provides cooling of the batteries and media as the batteries are being discharged. The heat transferred from the discharging batteries and media to the air can be harnessed for beneficial purposes.

In still another embodiment the method of discharging the batteries involves more than one type of bead. The first process consists of exposing a battery to a batch of beads that has a low conductivity. In this manner when the starting voltage is high the initial discharge process can be conducted with beads that have a lower conductivity resulting in less current flow and more gradual discharge and a lower heat generation rate. Once the battery voltage is below a certain level a different batch of beads with a higher conductivity can be used to provide a faster discharge rate.

In still another embodiment, if a battery has shielded terminals that can not be contacted due to the size of the beads being larger than the entry to the battery terminals then an electrical connector that fits the battery terminal and terminates in exposed conductive surfaces can be used. The conductive beads will contact the exposed conductive surfaces on the connector and discharge the battery.

In some electric vehicle battery modules individual batteries are connected to a busbar with an individual fuse wire. In still another embodiment the bead size is chosen such that the beads will contact the terminals in a battery module through the holes in the busbar so the battery cells can be discharged even if the fuse wire has been severed.

### Example 1

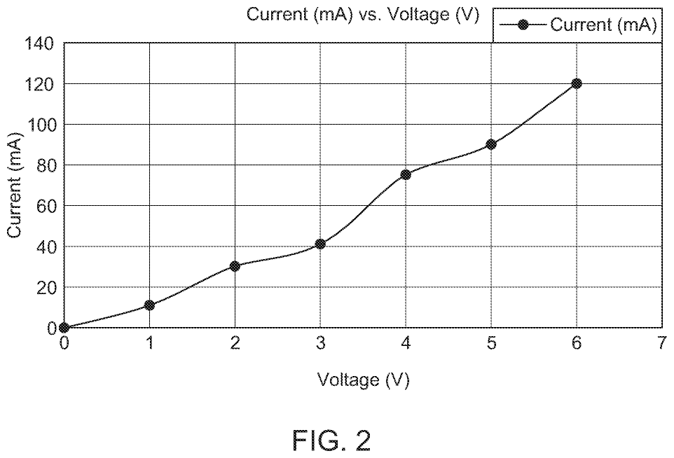

Polycarbonate beads with a cylindrical shape approximately 4 mm in height and 3 mm in diameter were tumbled in a drum while being sprayed with conductive nickel spray paint (MG Chemicals Super Shield Nickel Conductive Coating 841AR). The resulting nickel coated beads were used to cover a simulated 18650 Lithium Ion Battery and the resulting current vs. voltage trace for the simulated battery can be found in FIG. 2.

A charged Lithium Ion Battery of type 18650 was covered with the media at a starting voltage of 3.86V and was successfully discharged down to a voltage of 0.05V.

Those ordinarily skilled in the art should note that discharging batteries or other energy storage devices with an electrically conductive composite media is not limited to lithium ion batteries, as described herein, but is also applicable to other electrical energy storage devices where achieving a discharged state is desired/required.

The various embodiments and variations thereof described herein, including the descriptions in any appended claims and/or illustrated in the accompanying Figures, are merely exemplary and are not meant to limit the scope of the inventive disclosure. It should be appreciated that numerous variations of the invention have been contemplated as would be obvious to one of ordinary skill in the art with the benefit of this disclosure.

Examples of such variation may include, but not be limited to: the type and thickness of the conductive coating material, the size and shape of the beads that comprise the media, the final electrical properties of the beads and the composition of the core material.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A method for discharging electrical storage devices comprising:
a. providing an electrical storage device, wherein the electrical storage device comprises at least one positive terminal and at least one negative terminal;
b. providing a plurality of electrically conductive beads; and,
c. contacting said electrical storage device with said electrically conductive beads such that said electrically conductive beads contact the positive and negative terminals of said electrical storage device and create a contiguous electrical connection between a positive and negative terminal of said electrical storage device.

2. The method for discharging electrical storage devices of claim 1, wherein said electrical storage device is a Lithium ion battery.

3. The method for discharging electrical storage devices of claim 1, wherein said electrically conductive beads comprise an electrically insulating core surrounded by an electrically conductive coating.

4. The method for discharging electrical storage devices of claim 1, wherein said electrically conductive beads comprise carbon.

5. The method for discharging electrical storage devices of claim 1, wherein said electrically conductive beads comprise graphite.

6. The method for discharging electrical storage devices of claim 1, wherein said electrically conductive beads comprise a polymer and carbon fiber.

7. The method for discharging electrical storage devices of claim 1, wherein said electrically conductive beads comprise a polymer and a carbon fiber felt.

8. The method for discharging electrical storage devices of claim 1, wherein said electrically conductive beads comprise a metal foil.

8. The method for discharging electrical storage devices of claim 1, wherein forced air is used to cool said electrically conductive beads.
